(19) United States
(12) Patent Application Publication
(10) Pub. No.: US 2025/0173374 A1
(43) Pub. Date: May 29, 2025

(54) AUTOMATED NAME READER SYSTEM AND METHOD

(71) Applicant: The Regents of the University of Michigan, Ann Arbor, MI (US)

(72) Inventors: Swetha Rani KASIMALLA, Dearborn, MI (US); Aditya BENDALE, Dearborn, MI (US); Abhishek Ashok BORDE, Dearborn, MI (US); Abdul Kareem SHAIK, Dearborn, MI (US); Hafiz A. MALIK, West Bloomfield, MI (US)

(21) Appl. No.: 18/964,250

(22) Filed: Nov. 29, 2024

Related U.S. Application Data
(60) Provisional application No. 63/603,782, filed on Nov. 29, 2023.

(51) Int. Cl. G06F 16/638; G06F 3/16; G06F 16/68; G06F 21/62; G06K 7/14; G10L 13/02

(52) U.S. Cl. CPC G06F 16/638; G06F 3/165; G06F 16/686; G06F 21/6254; G06K 7/1417; G10L 13/02

(57) ABSTRACT

An automated named user audio presentation system and method, where the automated named user audio presentation system is configured to perform or cause performance of the method. The method is a method of outputting audio for one or more named users, and includes: receiving a named user code; identifying a named user based on the named user code; retrieving a named user audio file for the named user; retrieving named user information for the named user; and outputting the named user audio file and the named user information for the named user.

### TECHNICAL FIELD

This invention relates to providing audio for presentation during a live event, such as for uttering a name of an individual at a ceremony.

### BACKGROUND

Graduation ceremonies and other such award or recognition ceremonies of events often dedicate a portion of said event to recognizing individual persons for their achievements, particularly through a speaker speaking each of the individuals' names. Such ceremonies may range in size and kind, with many being particularly large events with tens, hundreds, or even thousands of attendees. An individual person is typically identified to be the “name reader” during the individual recognition stage of the event whereby this individual (the “speaker”) is to speak each named users' name aloud for the attendees to hear.

These ceremonies or events are performed for a variety of different recognition or award type events, each referred to herein generally as a “social event.” Oftentimes, such social events have a lot of named users that are to be individually recognized at the event through audible presentation of the named user's name. In many instances, the named users have diverse names, and it can be challenging for the speaker to speak each name in accord with the named user's preference (pronunciation). This is especially true when such a feat must be performed live in a setting with a large number of diverse names and/or unique pronunciations, such as at a graduation ceremony for a large number of students.

### SUMMARY

According to a first aspect of the invention, there is provided a method of outputting audio for one or more named users. The method includes: receiving a named user code; identifying a named user based on the named user code; retrieving a named user audio file for the named user; retrieving named user information for the named user; and outputting the named user audio file and the named user information for the named user.

According to various aspects of the invention, the first aspect is further characterized by any one or more (including any technically-feasible combination) of the following:
the named user code is a quick response (QR) code;
the named user code is provided to the named user as a part of a named user code generation process that is used to generate the QR code;
the named user code is received by using a QR code reader to read a physical representation of the QR code;
the physical representation of the QR code is a display of the QR code on a display screen of a named user device;
the named user device is a smartphone, tablet, or other handheld mobile computer;
the physical representation of the QR code is a hard copy or print-out of the QR code;
the named user audio file is stored with an anonymized filename;
the anonymized filename is generated by encrypting a named user identifier of the named user;
the named user audio file is initially obtained and stored prior to receiving the named user code;
the named user audio file is generated by the named user through a voice recording provided by the named user that takes an input configured by the named user;
the named user audio file is generated based on a language input provided by the named user;
the named user audio file includes automatically-generated speech;
the automatically-generated speech is generated based on the language input provided by the user using a text-to-speech (TTS) technique, and wherein the language input is text or spoken words;
the automatically-generated speech is generated based on a language specified by the named user and/or a dialect specified by the named user;
the named user information is information that is to be presented to at a predetermined social event;
the named user is one of a plurality of named users and each of the plurality of named users has an associated named user audio file and associated named user information;
the associated named user audio file for each of the plurality of named users is output via audio playback at the predetermined social event;
the associated named user information for each of the plurality of named users is output via visual playback at the predetermined social event;
the associated named user audio file and the associated named user information are output for playback at the predetermined social event in a coordinated manner so that the visual playback of the named user information occurs at the same time or within a predetermined amount of time as the audio playback of the named user audio file;
the predetermined amount of time is less than one minute;
the predetermined amount of time is less than one fifteen seconds;
the predetermined amount of time is less than one five seconds;
the named user is one of a plurality of named users and each of the plurality of named users has an associated named user audio file;
the predetermined social event is a graduation ceremony in which each of the plurality of named users has their name read aloud via audio playback of the associated named user audio file;
the method is performed by an automated named user audio presentation system having at least one processor and memory storing computer instructions that, when executed by the at least one processor, cause the method to be performed;
the method comprises a named user registration process, and wherein the named user registration process includes: generating the named user code for the named user, wherein the named user code is generated based on information pertaining to the named user, wherein the information pertaining to the user is a named user identifier; and providing the named user code to the named user;
the method comprises a named user playback process for a predetermined social event, and wherein the named user playback process includes: receiving the named user code; identifying the named user based on the named user code;
retrieving the named user audio file for the named user; retrieving the named user information for the named user; and outputting the named user audio file and the named user information for the named user;
the named user audio file includes automatically-generated speech;
the automatically-generated speech is generated based on a language input provided by the user, and wherein the language input is text or spoken words;
automatically-generated speech is generated based on a language specified by the named user and/or a dialect specified by the named user;
the named user audio file is obtained as a part of the named user registration process;
the named user is one of a plurality of named users and each of the plurality of named users has an associated named user audio file and associated named user information;
the associated named user audio file for each of the plurality of named users is output via audio playback at the predetermined social event;
the associated named user information for each of the plurality of named users is output via visual playback at the predetermined social event;
the associated named user audio file and the associated named user information are output for playback at the predetermined social event in a coordinated manner so that the visual playback of the named user information occurs at the same time or within a predetermined amount of time as the audio playback of the named user audio file;
the named user is one of a plurality of named users and each of the plurality of named users has an associated named user audio file;
the predetermined social event is a graduation ceremony in which each of the plurality of named users has their name read aloud via audio playback of the associated named user audio file; and/or
the named user registration process is performed for each of a plurality of named users including the named user before the named user playback process begins for any of the plurality of named users.

According to a second aspect of the invention, there is provided an automated named user audio presentation system. The automated named user audio presentation system includes: a user code generation subsystem configured to generate a unique named user code for each of a plurality of named users, a named user audio presentation subsystem having an electronic audio speaker, and a named user visual presentation subsystem having an electronic display. The unique named user code is used to individually identify a named user from the plurality of named users. The named user audio presentation subsystem is configured to receive the named user code or other information uniquely identifying an individual, to obtain a named user audio file based on the named user code, and to audibly output a name of each of the plurality of named users through audio playback of the named user audio file using the electronic audio speaker. The named user visual presentation subsystem is configured to receive information identifying a particular one of the plurality of named users, to obtain named user information for the particular named user, and to visually output the named user information for the particular named user using the electronic display.

According to various aspects of the invention, the second aspect is further characterized by any one or more (including any technically-feasible combination) of the characterizations recited above in connection with the first aspect and/or the following:
the named user audio presentation system is implemented using different hardware than that used for implementing the named user visual presentation system;
further comprising: an on-spot interface computer system comprising a named user information entry computer configured for receiving a name from a user and causing registration of the user as one of the plurality of named users;
the named user audio presentation subsystem, the named user visual presentation subsystem, and the on-spot interface computer system are co-located at an event space for a social event in which the name of each of the plurality of named users is to be audibly presented; and/or
the user code generation subsystem is remotely-located from the event space.

### BRIEF DESCRIPTION OF THE DRAWINGS

Preferred exemplary embodiments will hereinafter be described in conjunction with the appended drawings, wherein like designations denote like elements, and wherein:

FIG. 1 is a block diagram depicting a communications or operating system having: an automated named user audio presentation system, according to at least one embodiment;

FIG. 2 is a flowchart illustrating a method of outputting audio for one or more named users, according to at least one embodiment;

FIG. 3 is a flowchart illustrating a method of intaking information about a named user and for performing a named user registration process for the named user, according to at least one embodiment; and

FIG. 4 is a flowchart illustrating a method of providing an on-spot interface for configuring a named user audio file, a named user code, and/or named user information, according to at least one embodiment.

### DETAILED DESCRIPTION

The system and method described herein enables providing audio playback of one or more individuals' names, such as through using an electronic speaker for outputting one or more audio files, each of which is an audio file with speech of a name for a different individual/user. According to embodiments, an automated name reader system is provided, and is configured to perform a method for outputting audio for one or more named users. The method includes: receiving a named user code; identifying a named user based on the named user code; retrieving a named user audio file for the named user; retrieving named user information for the named user; and outputting the named user audio file and the named user information for the named user. In embodiments, the named user code is a quick-response (QR) code that is provided to the named user before a predetermined social event, such as a graduation ceremony, virtual award ceremony, or other event in which individuals gather for social purposes including, for example, recognition of one or more named individuals (the “named users”). QR codes or other named user codes are distributed to the students or named users, and such users then provide their QR code (or other named user code) to the system in preparation for being recognized via audio playback of the name of the named user using the named user's audio file, which is retrievable based on the QR code (or other named user code). Named user information, such as name, major(s) (and/or minor(s)) or other achievement information, and the named user identifier (ID), may be visually output, such as, for example, displaying text or other graphics indicating the named user information.

While the present embodiment is directed to outputting a named user audio file having audio of an individual's name, such as their first name and last name/surname, it will be appreciated that the system, method, and other described and/or suggested implements discussed herein may be adapted for use with audio files that do not have audio of an individual's name, but other selected audio for the named user.

According to embodiments, there is provided a named user registration process whereby a named user provides input for purposes of configuring an audio file representing audio that, when played audibly, speaks the name of the named user, such as a first name and surname or last name. The named user registration process provides a user interface, such as a graphical user interface (GUI), that enables the user to generate or otherwise configure the audio file for their name, which may be referred to as a “named user audio file”. In addition to configuring the named user audio file, the named user registration process allows the named user to enter user information, which may be tailored for the application or implementation in which the system or method is to be used. For example, in the context of using the present system and method for presentation at a graduation ceremony for a university, the user information may include, for example, the user's full name in text form, the user's school, any honors received by the user, any future plans of the user, etc.

Accordingly, in embodiments, there is provided a named user registration process that includes: generating a named user code for the named user, wherein the named user code is generated based on information pertaining to the named user, and providing the named user code to the named user. And, in at least some embodiments, the information pertaining to the user is a named user identifier.

After the named user registration process is performed, a named user playback process is performed for or at a predetermined social event. The named user playback process includes the steps of the method for outputting audio for one or more named users above, and these steps may be performed for each named user for which a named user code is received.

In embodiments, the system and method provide an “on-spot” or “on-location” user registration/information entry feature that allows a named user to configure their named user audio file and/or other user information at a computer client machine located at the location at which the named user audio file and other information is to be presented. This on-spot interface computer system, thus, allows people to register as named users even if they have not done so prior to arriving at the location of the event at which the named user audio file and/or user information is to be presented. For example, in the context of a graduation ceremony, there may be a name reader that reads the names of the named users aloud for an audience. In many instances, the names of the named users are diverse and pronunciation of the names proves to be challenging without having personal knowledge or other contextual information as the textual characters of a name do not necessarily indicate precisely how a name is pronounced. The named user may use the on-spot computer system to provide input regarding how their name is pronounced, or may even provide audio that is recorded by the on-spot computer system that is used as the named user audio file for the named user. In embodiments where the named user does not generate audio captured by the on-spot computer system, the named user audio file may be generated using a text-to-speech technique, for example.

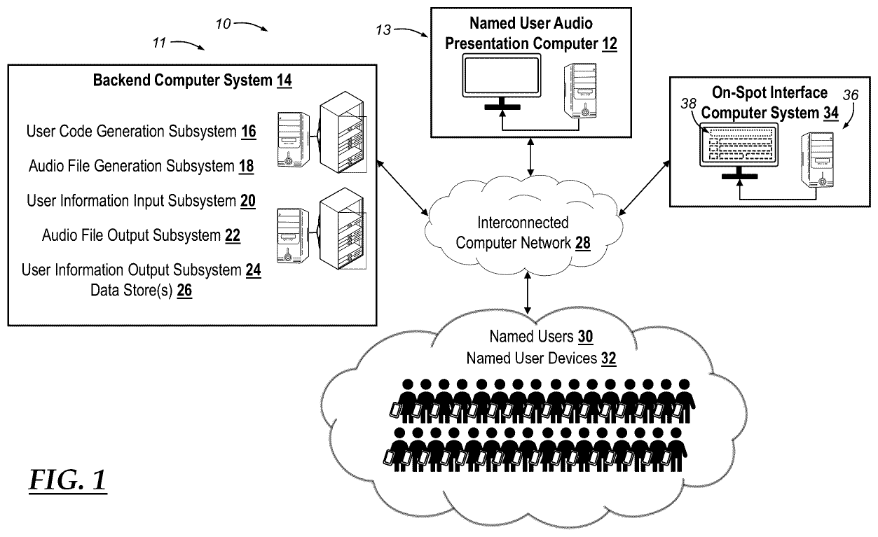

With reference to FIG. 1, there is shown a communications or operating system 10 that includes: an automated named user audio presentation system 11 comprising a named user audio presentation computer 12 and a backend computer system 14 with subsystems 16-24 and one or more data store(s) 26; interconnected computer network 28; named users 30 each with a named user device (collectively referred to as “named user devices”) 32; and on-spot interface computer system 34. The interconnected computer network 28 is used to enable computer systems to communicate with one another, such as for communications between the named user audio presentation computer 12, the named user audio presentation backend computer system (or simply the “backend computer system”) 14, the named user devices 32, and the on-spot interface computer system 34.

Each computer system, computer subsystem, or computer machine discussed herein (e.g., the named user audio presentation computer 12, the backend computer system 14, the named user devices 32, and the on-spot interface computer system 34) includes at least one processor and memory storing computer instructions accessible by the at least one processor. It will be appreciated that multiple subsystems or systems may share the same computer machines, and that the systems or subsystems herein are not limited to being separate from one another, unless stated so. According to embodiments, the hardware of each computer system need not necessarily all be co-located, but may be distributed and, according to embodiments, cloud platforms or software services offered by cloud providers may be used.

The named user audio presentation computer 12 is a computer that is present at an event, such as a graduation ceremony or other predetermined social event, and that is used for outputting named user audio files for audio playback at the event so that event attendees (e.g., audience members at the graduation ceremony) may hear the names. The named user audio presentation computer 12 may also be used for outputting named user information that is presented to the event attendees, such as through displaying the named user information as text and/or graphics on a display screen (e.g., a large projector screen, a shared webcast screen for when the event is a virtual or web event). The named user audio presentation computer 12 is shown as being a part of a named user audio presentation frontend computer system (or simply “frontend computer system”) 13 that includes the single named user audio presentation computer 12; however, in other embodiments, the named user audio presentation frontend computer system 13 includes more than one computer that is used for outputting the named user audio file and the named user information, and/or otherwise performing those functions and having those characteristics attributed to the single named user audio presentation computer 12 of the present embodiment.

The automated named user audio presentation system 11 is configured to output an audio file for one or more of the named users 30. The automated named user audio presentation system 11 includes multiple subsystems 16-24 within its backend computer system 14 and also includes the named user audio presentation computer 12 that is used to output the named user audio file so as to cause audio playback of the named user audio file. As mentioned above, each subsystem 16-24 may be implemented by one or more processors and memory, and these hardware devices may be shared amongst subsystems, according to some embodiments. For example, code or computer instructions used for multiple ones of the subsystems 16-24 may be shared by the different subsystems. Also, each of the subsystems 16-24 accesses, stores, deletes, updates/changes, and/or otherwise modifies or obtains data in electronic or computer-readable format, and this data may be stored in one or more data stores 26.

The data store(s) 26 may be implemented through any one or more of the previously-mentioned memory devices or other suitable memory devices. The data store(s) 26 may be cloud hosted data stores, such as DynamoDB™ hosted by Amazon™ Web Services (AWS), for example. The data store(s) 26 are used to store computer-readable data, such as the named user information, the named user codes, the name user audio files, and other information used by the automated named user audio presentation system 11.

The backend computer system 14 includes a user code generation subsystem 16, an audio file generation subsystem 18, a user information input subsystem 20, an audio file output subsystem 22, and a user information output subsystem 24. Each subsystem 16-24 is implemented through executing computer instructions using at least one processor, as mentioned above. In embodiments, one or more of the subsystems 16-24 is implemented using cloud hosted services, such as those provided by Amazon™ Web Services, Google™ Cloud Platform, or Microsoft™ Azure™, for example.

The user code generation subsystem 16 is configured to generate a named user code for each named user, where the named user code is used to uniquely identify the named user amongst a plurality of named users. The named user code may be encoded using one or more representations, such as a string, a number, or an array, for example. In one embodiment, the named user code is represented by a quick response (QR) code or other two-dimensional matrix barcode. The QR code may be provided as a computer graphic (e.g., an image file (e.g., portable network graphic (PNG), JPEG)) and/or may be printed onto paper by an ink printer so that the user has a hard or physical copy of the named user code. In embodiments, the named user device 32 of the named user 30 is used to store the named user code, such as by storing an image file that has the QR code depicted therein. In embodiments, the named user code is to be presented by the named user 30 during a presentation at the predetermined social event so that the named user audio file and named user information may be quickly and swiftly recalled for the presentation at the appropriate time, such as when the named user 30 is about to walk across the stage during a graduation ceremony, for example.

The user code generation subsystem 16 executes a named user code generation process that generates a named user code for a named user and this process may be run for each named user of a plurality of named users. In embodiments, the named user code is a pseudorandom code, such as an alphanumeric string or array of numbers, which may be generated using any of a variety of pseudorandom number generators (PRNGs), for example. In some embodiments, information about the named user, such as a student identifier or other unique information, is used as a basis for generating the named user code so that, upon input of the same user information (e.g., student identifier), the same output would be generated. In embodiments, anonymity or privacy may be enforced through first encrypting the student identifier (or other user information) prior to encoding it into the named user code, such as a QR code. The user information may be encrypted using an encryption key and a decryption key may be used to decrypt the encrypted user information to obtain the user information. A private or symmetric encryption key scheme or public key scheme may be used.

The audio file generation subsystem 18 is configured to generate or otherwise obtain a named user audio file, which is an audio file having data that, when output audibly, speaks a name of the named user associated with the named user audio file. Accordingly, the audio file generation subsystem 18 is used to generate a named user audio file for each named user of the plurality of named users 30. The named user audio file may be stored in any suitable form, such as a WAV (Waveform Audio File Format), MP3 (MPEG-1 Audio Layer III), AAC (Advanced Audio Coding), FLAC (Free Lossless Audio Codec), OGG (Ogg Vorbis), AIFF (Audio Interchange File Format), or WMA (Windows™ Media Audio), for example. In embodiments, the named user audio file is initially recorded by the named user, and then uploaded to the audio file generation subsystem 18, which may then process the named user audio file, as discussed below. Additionally, or alternatively, a named user audio file for a named user may be generated programmatically by the audio file generation subsystem 18, such as through use of text-to-speech technology. Exemplary text-to-speech (TTS) technology that may be used, in embodiments, for example, include Google's Text-to-Speech, Amazon Polly, IBM Watson Text to Speech, and Microsoft Azure's Text to Speech service. These platforms offer realistic and natural-sounding voices in multiple languages and dialects, and the name of the named user may be input as text, along with other preferences, such as a preferred voice and language, and the system will generate an audio file of the spoken text.

The user information input subsystem 20 is configured to obtain user information about named users, particularly user information that is to be presented to an audience; this information may be referred to herein as “named user information”. The audience are those individuals in attendance (e.g., in person, virtually through a videocall or webcast) at a predetermined social event. As used herein, a “predetermined social event” is an in-person or virtual gathering of individuals, such as a graduation ceremony, an award ceremony, a class gathering, etc. The named user information accommodates the named user audio file during its presentation, such as through displaying the named user information on a display screen (e.g., projector screen, television screen) when the audio file is being played for audio playback. For example, the named user information may include information about a student's graduation or background, such as college from which the student is presently graduating, any honors received, future prospects, current/past residence, etc., and this named user information may be presented on a display screen while the name of the named user is read aloud for the audience. The named user information may be received from the named user, such as from the named user 30 using the named user device 32, which may be a smartphone for example, to input the named user information into a graphical user interface (GUI) that then provides the information to the user information input subsystem 20 whereat the named user information is stored in a data store. The named user information is associated with the named user, such as through associating the named user information in the data store with the named user code or other named user identifier.

The audio file output subsystem 22 is used to provide named user audio files so that the named user audio files may be presented, namely output at a speaker for audio playback. The named audio files for the named users 30 may be stored in the data store(s) 26 of the backend computer system 14, and the audio file output subsystem 22 is configured to retrieve the named user audio file for a named user code input into the audio file output subsystem 22. For example, in one embodiment, the named user code is presented by a named user 30, and then the named user code is used by the audio file output subsystem 22 to retrieve the named user audio file for that named user 30 so that the correct audio file is selected for output. In embodiments, the audio file output subsystem 22 sends the named user audio file over a suitable network connection, such as HTTP/HTTPS (Hypertext Transfer Protocol/Secure). For example, the named user audio file may be streamed for real-time playback.

The user information output subsystem 24 is used to provide named user information so that the named user information may be presented, such as for display on a display screen. The named user information for the named users 30 may be stored in the data store(s) 26 of the backend computer system 14, and the user information output subsystem 24 is configured to retrieve the named user information for a named user code input into the user information output subsystem 24. For example, in one embodiment, the named user code is presented by a named user 30, and then the named user code is used by the user information output subsystem 24 to retrieve the named user information for that named user 30 so that the correct user information is selected for output. In embodiments, the user information output subsystem 24 sends the named user information over a suitable network connection, such as HTTP/HTTPS (Hypertext Transfer Protocol/Secure). For example, the named user information may be streamed for real-time display or other presentation.

The on-spot interface computer system 34 includes a named user information entry client machine (also referred to as an “on-spot interface computer”) 36, which is a computer usable by a user to enter information into the automated named user audio presentation system 11. The on-spot interface computer 36 is used to provide a graphical user interface (GUI) usable by named users for configuring named user audio files and/or named user information, and this GUI is referred to as an on-spot interface form (or “named user entry interface”) 38 and is illustrated as a GUI in FIG. 1. The on-spot interface form 38 may be embodied in software or other computer instructions that is provided by the backend computer system 14 to the on-spot interface computer 36. The on-spot interface form 38 may be used for obtaining information about a user as a part of a named user registration process.

In embodiments, the on-spot interface form 38 is made available for named users (e.g., students) who have not filled out the information on the named user information entry form prior to an event. The named user information entry form is a form used to enter information for a named user and may be accessible via the internet and implemented via a web application on a web browser, for example. In embodiments, the named user information entry form is a CANVAS™ or Google™ form. In one embodiment where the on-spot interface form 38 is used for students of a graduation ceremony, a GUI window of the on-spot interface form 38 allows the operator (likely the named user) to fill out a small form and select the language code based on the student's background. This selection helps generate an AI voice using the text-to-speech API.

Within the on-spot interface form 38, a GUI window is rendered which is used to collect named user information, such as information considered required by an organization for an event, such as student data or information for a graduation ceremony. This data may be initially stored in variables, and a text-to-speech API, such as the one provided by Google™, may be utilized to generate an artificial intelligence (AI) voice based on a dialect and language, each of which may be selected or otherwise input by the user. After anonymization and normalization, the audio file is saved in mp3 format and stored in Google™ Storage, for example. The data collected through the on-spot interface form 38 may be stored in the same BigQuery database used for preprocessing. If any existing data matches the named user identifier (e.g., student ID), it may be replaced with the data received from this form, as will be discussed more below. A QR code (or other named user code) may be created, uploaded to Google™ Storage (or another data store, such as those that may be used for the data store(s) 26), and then sent to the named user, such as via an email address of the named user (e.g., a student's email address).

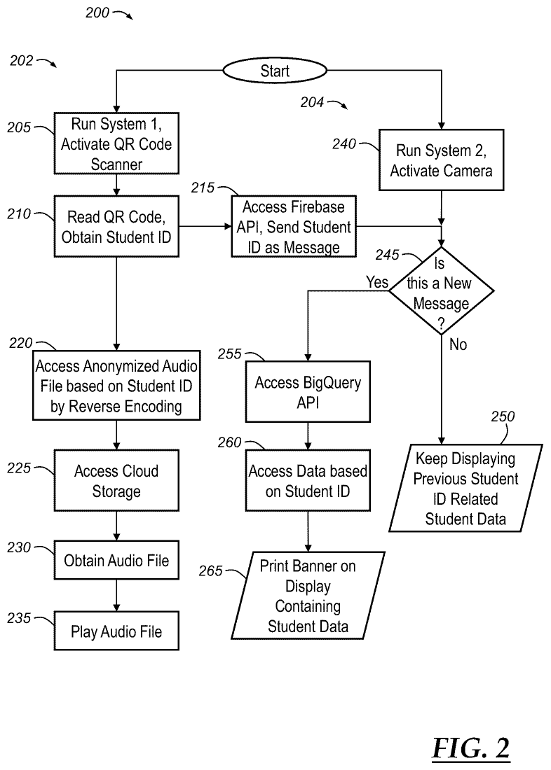

With reference to FIG. 2, there is shown an embodiment of a method 200 of outputting audio for one or more named users. The method 200 is performed by the automated named user audio presentation system 11, at least in embodiments. While the method 200 discusses certain steps as being performed in a particular order, the steps of the method 200 may be performed in any technically-feasible order, as will be appreciated by those skilled in the art. The method 200 includes two processes: a process 202 for playing a named user audio file and a process 204 for presenting named user information. The process 202 and the process 204 may be performed at the same time (in parallel) and, in particular, in the depicted embodiment, the process 204 awaits a message from the process 202, as will be discussed more below.

The method 200 and the process 202 both begin with step 205, wherein a named user code reader is activated, such as a QR code scanner/reader that may be executed on a smartphone or tablet, for example. The named user code reader is an electronic device that is used to transform a printed version or other visual display (e.g., a QR code on a smartphone display screen) of a code into computer-readable data. The named user code reader may be a smartphone with a QR scanning application that uses the smartphone's camera to identify and read a QR code. The process 202 continues to step 210.

In step 210, the named user code is received and, as shown in the depicted embodiment, the QR code (acting as the named user code in the depicted embodiment) is read and a named user identifier (the “Student ID” or student identifier in the depicted embodiment) is obtained using the named user code. In one embodiment, the named user identifier is encoded in the named user code. A QR code reader, such as one that is implemented as a smartphone app, may be used to interpret the QR code in order to obtain a digital or computer-readable representation of the data. This data may be decoded and/or decrypted, such as through using the decryption key noted above, in order to obtain named user information and/or other information. In one example, the data read by the QR code reader is then decrypted using the decryption key and this decrypted data is then stored in memory. The process 202 continues to steps 215 and 220.

In step 215, the process 204 is informed by the first process 202 of an input named user identifier. In the depicted embodiment, step 215 includes accessing Firebase™ API to send a student identifier (the named user identifier in the present embodiment).

In step 220, the named user identifier is used to determine an audio file key that specifies or identifies the named user audio file for the named user associated with the named user code. The audio file key is an identifier used to obtain the named user audio file and may also be the filename of the named user audio file. The filename of the named user audio file may be anonymized so that the identity of the named user of the named user audio file may be kept private. The filename may be generated by using an encryption key with the named user identifier, for example. In another embodiment, the filename of the named user audio file is pseudorandomly generated and the association between the filename and the named user are kept in a secured data store. The process 202 continues to step 225.

In step 225, the data store is accessed in order to obtain the named user audio file, as shown in step 230. The named user audio file is accessed and obtained through the audio file key or filename. The named user audio file is obtained through downloading the named user audio file from the data store(s) 26 to the named user audio presentation computer 12 whereby the named user audio presentation computer 12 is used to cause the named user audio file to be output for audio playback, such as by playing the named user audio file on loudspeakers, which is performed in step 235. The process 202 ends.

In step 240 of the process 204, a camera is activated and the camera is used to provide a live video feed of individuals (e.g., speakers, named users) so that the live video feed may be output in real-time to a display, such as a projector screen. This live feed is provided for visual playback/output at the predetermined social event. The process 204 continues to step 245.

In step 245, it is determined whether a new message is received from the process 202, as indicated at step 215. When a new message is not received, the process 204 proceeds to step 250; when a new message is received, the process 204 proceeds to step 255. In step 250, named user information of a previous named user is displayed.

In step 255, access to a data store provider, such as BigQuery API, is made and, in step 260, access to named user information based on a named user identifier is performed. The named user identifier may be obtained from the message from the first process 202 at step 215. The process 204 continues to step 265.

In step 265, the named user information is output for visual display, such as through printing the named user information (e.g., student data) onto a banner or electronic display. In embodiments, the associated named user audio file and the associated named user information are output for playback at the predetermined social event in a coordinated manner so that the visual playback of the named user information occurs at the same time or within a predetermined amount of time as the audio playback of the named user audio file. In embodiments, the predetermined amount of time is less than one minute, less than thirty seconds, less than fifteen seconds, or less than five seconds. The process 204 then ends. The method 200 may loop back for continued execution and may be used for performing numerous iterations, each for a different named user that presents a named user code at step 205.

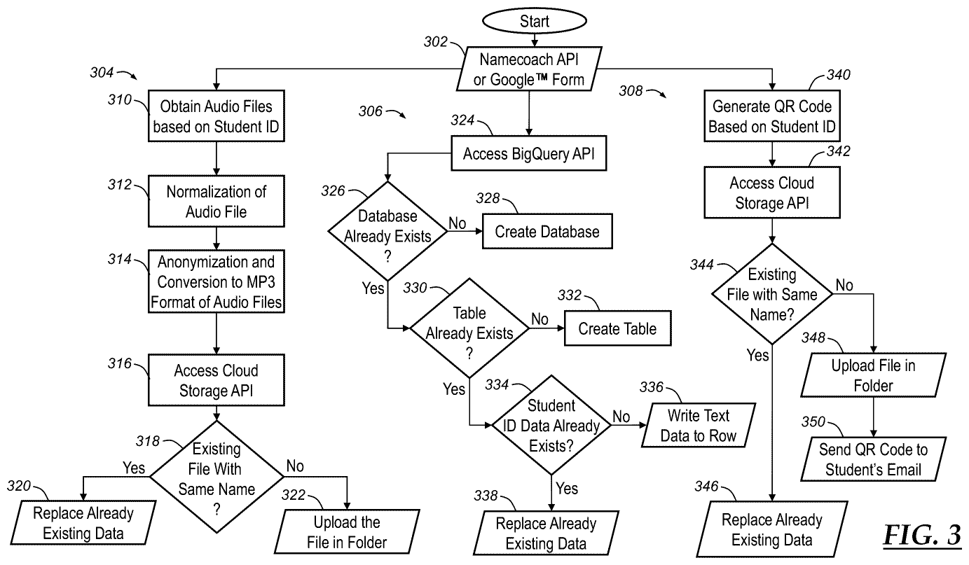

With reference to FIG. 3, there is shown an embodiment of a method 300 of intaking information about a named user and for performing a named user registration process for the named user. The method 300 is performed by the automated named user audio presentation system 11, at least in embodiments. While the method 300 discusses certain steps as being performed in a particular order, the steps of the method 300 may be performed in any technically-feasible order, as will be appreciated by those skilled in the art. The method 300 includes three processes: a process 304 for configuring a named user audio file for a named user; a process 306 for configuring named user information for a named user; and a process 308 for configuring a named user code for a named user.

The method 300 is shown as beginning with step 302, wherein a named user information entry form is initialized, and which may use Google™ forms and/or Namecoach™ API. The processes 304-308 may be performed separately from one another, and may each be performed for a plurality of named users.

The process 304 begins with step 310, wherein a named user audio file is retrieved using a named user identifier, which is shown as a student identifier in the illustrated embodiment. The process 304 continues to step 312.

In step 312, normalization of the named user audio file is performed. Normalization here refers to modifying an audio file in order to cause the audio file to be audibly consistent with one or more other audio files, such as where the volume of the audio file is adjusted and/or where start and end quiet intervals are achieved. For example, adjusting the volume to be consistent for a plurality of named user audio files that are to be output for audio playback in a back-to-back fashion (i.e., each playback one after the other consecutively in time) improves the listening experience, as does ensuring a consistent amount of no speech/quiet period between the beginning of the file and the first utterance as well as between the last utterance and the end of the file. In some embodiments, the named user audio file may be checked to determine whether it complies with one or more predetermined conditions, such as those relating to decency (e.g., ensuring inappropriate words or phrases are not present). This may be done using a speech-to-text (STT) technique to obtain text and then processing the text to determine whether there are no inappropriate words or phrases present. Other techniques may be used in other embodiments. The process 304 continues to step 314.

In step 314, a filename that is anonymous is generated for the named user audio file and, also in the depicted embodiment, the named user audio file is converted to an MP3 file. As discussed above, the filename of the named user audio file may be anonymized so that the identity of the named user of the named user audio file may be kept private. The filename may be generated by using an encryption key with the named user identifier, for example. In another embodiment, the filename of the named user audio file is pseudorandomly generated and the association between the filename and the named user are kept in a secured data store. The named user audio file is converted to a predetermined audio file type, which is MP3 in the depicted embodiment, but any of a variety of audio file types, such as those mentioned herein, may be used. Also, in some embodiments, this step is performed before step 312. The process 304 continues to step 316.

In step 316, a data store holding named user audio files is accessed and, in the depicted embodiment, this is performed by accessing cloud-based storage using an API. The process 304 continues to step 318.

In step 318, it is determined whether an audio file with the same filename (or an audio file for the same named user) exists. This may include comparing the determined filename from step 314. When it is determined that a file with the same filename exists, the process 304 proceeds to step 320; otherwise, the process 304 proceeds to step 322.

In step 320, the named user audio file that already existed is replaced with the new named user audio file processed in steps 310-314. This may include storing the named user audio file in the data store(s) 26.

In step 322, the named user audio file is stored. For example, the named user audio file is stored in the data store(s) 26. In one embodiment, the named user audio file is stored in AWS S3. However, other suitable data stores may be used. The process 304 ends.

The process 306 for configuring named user information for a named user begins with step 324, wherein a data store holding named user information is accessed. The data store may be accessed by connecting a client with a cloud managed data warehouse, such as BigQuery™ by Google™. The process 306 proceeds to step 326.

In step 326, it is determined whether a database already exists for named user information storage. When using BigQuery™, for example, a database here corresponds to a dataset and so this step may be performed by determining whether a dataset already exists. When it is determined that a database for named user information storage already exists, the process 306 proceeds to step 330; otherwise, the process 306 proceeds to step 328. In step 328, a database, such as a dataset in BigQuery™, is created in order to hold named user information.

In step 330, it is determined whether a database table within the database already exists for named user information storage. When it is determined that a database table within the database for named user information storage already exists, the process 306 proceeds to step 334; otherwise, the process 306 proceeds to step 332. In step 332, a table for holding named user information is created.

In step 334, it is determined whether a named user information entry for the named user already exists within the database table. In one embodiment, this may include determining whether the named user identifier, such as a student ID, already exists. When it is determined that a named user information entry for the named user already exists within the database table, the process 306 proceeds to step 338; otherwise, the process 306 proceeds to step 336.

In step 336, the named user information is stored in the database table as a new entry.

In step 338, the named user information is stored in the database table and replaces the old entry for the named user. The process 306 ends.

The process 308 for configuring a named user code for a named user begins with step 340, wherein the named user code for the named user is generated and, in embodiments, is generated based on a named user identifier. In the depicted embodiment, the named user code is a quick response (QR) code and is generated based on a student identifier, which is the named user identifier in this example. In embodiments, there is one named user code generated and attributed to one named user so that there is a one-to-one relationship between named user codes and named users (and also named user identifiers as there is a single named user identifier per named user). The process 308 continues to step 342.

In step 342, a data store holding named user codes is accessed. The data store may be one of the data store(s) 26. The process 308 continues to step 344.

In step 344, it is determined whether a file with the same filename already exists. A filename for storing the named user code is determined, and this filename may be generated based on the named user code and/or the named user identifier. The filename may be generated consistently based on the named user identifier and/or named user code so that only a single named user code is stored per named user. When it is determined that a file with the same filename already exists, the process 308 proceeds to step 346; otherwise, the process 308 proceeds to step 348.

In step 346, the named user code that existed prior to step 340 is then replaced with the named user code generated in step 340. This may include overwriting an entry in the data store(s) 26 with a named user code entry having the named user code generated in step 340.

In step 348, the named user code is stored in the data store. A new entry in the data store(s) 26 may be made where the new entry includes the named user code generated in step 340. The process 308 continues to step 350.

In step 350, the named user code is sent to the named user. In the depicted embodiment, the named user is a student and the named user code is a QR code and is sent to the student via an email message having the QR code and addressed to the student's email address. In other embodiments, a short message service (SMS) message having the named user code may be sent to a phone number of the named user. In other embodiments, other means of communicating the named user code to the named user may be used. The process 308 ends.

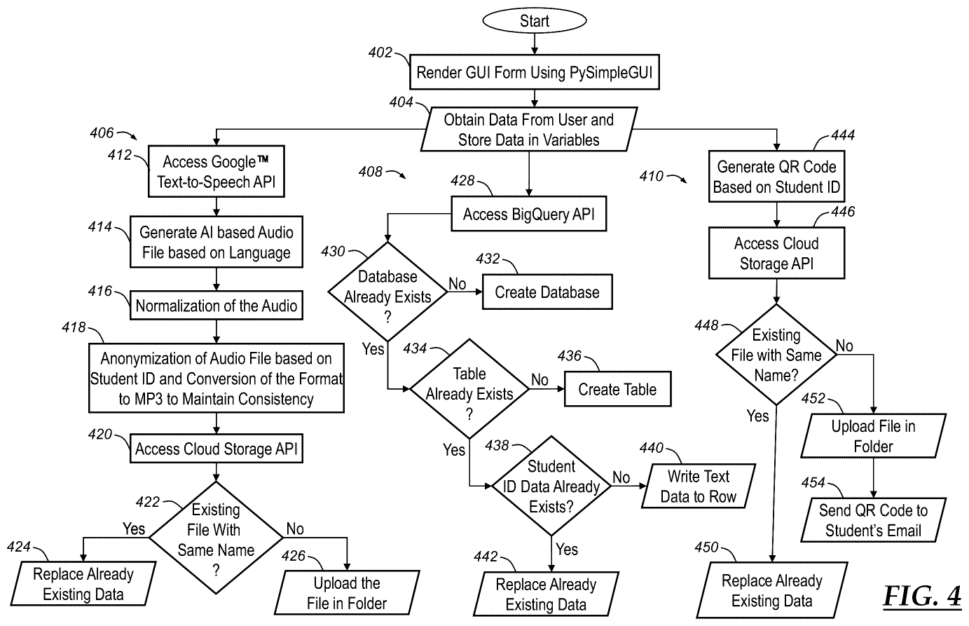

With reference to FIG. 4, there is shown an embodiment of a method 400 of providing an on-spot interface for configuring a named user audio file, a named user code, and/or named user information. The method 400 is performed by the automated named user audio presentation system 11, with at least some steps being performed by the on-spot interface computer system 34, at least in embodiments. While the method 400 discusses certain steps as being performed in a particular order, the steps of the method 400 may be performed in any technically-feasible order, as will be appreciated by those skilled in the art. The method 400 includes two provisional steps 402-404 that render the graphical user interface (GUI) used to operate the on-spot interface and obtain initial data for the interface, and then the method 400 further includes three processes: a process 406 for configuring a named user audio file for a named user; a process 408 for configuring named user information for a named user; and a process 410 for configuring a named user code for a named user.

The process 406 is shown as beginning with step 412, wherein a text-to-speech service is accessed, such as accessing Google's text-to-speech API. This may include performing authorization with an API key in order to receive an authorization token used for requests, for example. The process 406 continues to step 414.

In step 414, a named user audio file is automatically generated using a text-to-speech (TTS) technique. In one embodiment, the TTS technique may be a TTS technique implemented via a TTS service, such as Google™ Text-to-Speech, Amazon™ Polly, IBM Watson™ Text to Speech, or Microsoft Azure™ Text to Speech. The TTS service may specify an API and this API may be used to generate an audio file from text. File type, language, dialect, and other parameters may be specified for generation of the audio file, at least in embodiments. The process 406 continues to step 416.

In step 416, the named user audio file is normalized. Normalization was discussed in connection with step 312 and that discussion is hereby incorporated and attributed to the step 416 to the extent it is not inconsistent with the discussion of the step 416. The process continues to step 418.

In step 418, a filename for the named user audio file is determined and it may be determined based on the named user identifier, such as a student identifier. Also, if needed, the named user audio file may be converted to a different and uniform file type, such as MP3. The process 406 continues to step 420.

In step 420, a data store for storing the named user audio file is accessed. The data store may be one of the data store(s) 26 of the backend computer system 14. The process 406 continues to step 422.

In step 422, it is determined whether an audio file with the same filename (or an audio file for the same named user) exists. This may include comparing the determined filename from step 418. When it is determined that a file with the same filename exists, the process 406 proceeds to step 424; otherwise, the process 406 proceeds to step 426.

In step 424, the named user audio file that already existed is replaced with the new named user audio file processed in steps 414-418. This may include storing the named user audio file in the data store(s) 26.

In step 426, the named user audio file is stored. For example, the named user audio file is stored in the data store(s) 26. In one embodiment, the named user audio file is stored in AWS S3. However, other suitable data stores may be used. The process 406 ends.

The process 408 and the process 410 are analogous to the process 306 and the process 308, respectively, and the discussion of each of the steps 428-442 (process 408) and steps 444-454 (process 410) will not be repeated expressly for the brevity.

According to embodiments, the on-spot interface computer system 36 is configured to present the named user entry interface 38 and to implement one or more of: the process 406, the process 408, and the process 410. In at least one embodiment, the on-spot interface computer system 36 is configured to implement the method 400 and/or cause the method 400 to be performed, including each of: the process 406, the process 408, and the process 410.

With reference now, again, to the specification as a whole, it will be appreciated that each of the one or more of the processors discussed or taught herein is to be understood as being electronic hardware used to perform one or more functions as a result of executing computer instructions using the electronic hardware, particularly where the electronic hardware is an electronic processor or processing unit configured to process the computer instructions so as to perform (i.e., perform itself or otherwise cause performance of) the one or more functions. In this regard, each processor discussed herein is implemented as electronic hardware suitable for processing computer instructions so as to perform its attributed functionality through processing computer instructions, and the particular type or types of processor used may be selected based on the application in which it is to be used;

in other words, the type(s) of processor for each of the processor(s) discussed herein used is/are selected based on its (the processor's) attributed functionality as will be appreciated by those skilled in the art in light of the teachings herein. Examples of types of electronic processors that may be used include central processing units (CPUs), graphics processing units (GPUs), field-programmable gate arrays (FPGAs), application specific integrated circuits (ASICs), microprocessors, microcontrollers, etc.

Further, the term “at least one processor” and any equivalent term (e.g., “one or more processors”) refers to one or more processors. The one or more processors refers to any such processors and, in interpretations of constituting a plurality of processors, includes any two or more processors, regardless of whether the two or more processors are co-located or remotely-located, and regardless of whether the two or more processors are of the same processor type or not. Accordingly, the term “at least one processor” and any equivalent phrases used herein each refers to electronic hardware that may include a plurality of processors, whether integrated into a single hardware component or distributed across multiple hardware components, including processors housed, manufactured, or packaged into separate commercial or sellable products or systems, as well as processors that are geographically or logically remote from one another, operating in coordination to perform the attributed functionality.

Each data store (and equivalent described or taught herein is understood as an ontological construct for organizing and/or structuring, as well as retaining data non-transitorily for later processing or retrieval, and is further understood as being implemented using non-transitory, computer-readable memory. The term “non-transitory, computer-readable memory” or its shorter form (“memory”) refers to electronic hardware for non-transitorily retaining data; further, this term is not to be understood as requiring a single hardware manufacture (e.g., a single solid state drive (SSD) memory chip), unless expressly and clearly indicated as such, meaning that this term covers electronic hardware comprised of a plurality of hardware manufactures, including those that are housed, manufactured, or packaged into different commercial or sellable products or manufactures, as well as those that are remotely-located from one another.

In this context, the term “data store” and its equivalent terms each generally refers to a predefined ontological framework defined by multiple inter-related schemas or ontologically-defined relationships arranged in a logical architecture for storing information; in this context, and as will be appreciated by those skilled in the art in light of the teachings herein, means that such “data store” is implemented through memory managed by a data store manager, where the “data store manager” refers to at least one processor configured to retrieve and/or store (i.e., write) data to the memory implementing the data store. In this regard, reference to any physical manifestation of “data store” or “data storage” will be understood to refer to the memory implementing the data store or storage.

Each of the one or more memory discussed or taught herein is understood as being electronic hardware used to retain or store data as a result of being configured with suitable electronic structures for such storage, particularly where the electronic hardware comprises a storage medium or memory unit configured to store data in a manner suitable for enabling subsequent retrieval or processing. In this regard, each data storage or memory component discussed herein is implemented as electronic hardware suitable for storing data so as to facilitate its attributed functionality through appropriate storage mechanisms, and the particular type or types of storage or memory used may be selected based on the application in which it is to be used; in other words, the type(s) of data storage or memory for each of the storage or memory components discussed herein used is/are selected based on its (the storage or memory component's) attributed functionality as will be appreciated by those skilled in the art in light of the teachings herein.

Examples of types of memory that may be used include including magnetic or optical disc drives, ROM (read-only memory), solid-state drives (SSDs) (including other solid-state storage such as solid-state hybrid drives (SSHDs)), other types of flash memory, hard disk drives (HDDs), non-volatile random access memory (NVRAM), etc. In embodiments, the memory or data store(s) are implemented through any one or more of the previously-mentioned memory devices or other suitable memory devices, and are hosted over the internet or on the cloud. Such cloud-hosted data stores may be implemented using, for example, any of a variety of cloud-hosted data storage platforms, such as DynamoDB™ hosted by Amazon™ Web Services (AWS), for example. It will be appreciated that the computers or computing devices having the memory and/or the at least one processor may include other memory, such as volatile RAM that is used by the electronic processor, and/or may include multiple electronic processors including various types of processors.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of outputting audio for one or more named users, comprising the steps of:
receiving a named user code;
identifying a named user based on the named user code;
retrieving a named user audio file for the named user;
retrieving named user information for the named user; and
outputting the named user audio file and the named user information for the named user.

2. The method of claim 1, wherein the named user code is a quick response (QR) code, and wherein the named user code is provided to the named user as a part of a named user code generation process that is used to generate the QR code.

3. The method of claim 2, wherein the named user code is received by using a QR code reader to read a physical representation of the QR code.

4. The method of claim 3, wherein the physical representation of the QR code is a display of the QR code on a display screen of a named user device, and wherein the named user device is a smartphone, tablet, or other handheld mobile computer.

5. The method of claim 3, wherein the physical representation of the QR code is a hard copy or print-out of the QR code.

6. The method of claim 1, wherein the named user audio file is stored with an anonymized filename, and wherein the anonymized filename is generated by encrypting a named user identifier of the named user.

7. The method of claim 1, wherein the named user audio file is initially obtained and stored prior to receiving the named user code, and wherein the named user audio file is generated by the named user through a voice recording provided by the named user and/or by a text-to-speech (TTS) technique that takes an input configured by the named user.

8. The method of claim 7, wherein the named user audio file includes automatically-generated speech, wherein the automatically-generated speech is generated based on a language input provided by the user, and wherein the language input is text or spoken words.

9. The method of claim 8, wherein the automatically-generated speech is generated based on a language specified by the named user and/or a dialect specified by the named user.

10. The method of claim 1, wherein the named user information is information that is to be presented to at a predetermined social event.

11. The method of claim 10, wherein the named user is one of a plurality of named users and each of the plurality of named users has an associated named user audio file and associated named user information, wherein the associated named user audio file for each of the plurality of named users is output via audio playback at the predetermined social event, and wherein the associated named user information for each of the plurality of named users is output via visual playback at the predetermined social event.

12. The method of claim 11, wherein the associated named user audio file and the associated named user information are output for playback at the predetermined social event in a coordinated manner so that the visual playback of the named user information occurs at the same time or within a predetermined amount of time as the audio playback of the named user audio file, and wherein the predetermined amount of time is less than one minute.

13. The method of claim 10, wherein the named user is one of a plurality of named users and each of the plurality of named users has an associated named user audio file, and wherein the predetermined social event is a graduation ceremony in which each of the plurality of named users has their name read aloud via audio playback of the associated named user audio file.

14. The method of claim 1, wherein the method is performed by an automated named user audio presentation system having at least one processor and memory storing computer instructions that, when executed by the at least one processor, cause the method to be performed.

15. The method of claim 1, wherein the method comprises a named user registration process, and wherein the named user registration process includes:
generating the named user code for the named user, wherein the named user code is generated based on information pertaining to the named user, wherein the information pertaining to the user is a named user identifier;
providing the named user code to the named user.

16. The method of claim 15, wherein the method comprises a named user playback process for a predetermined social event, and wherein the named user playback process includes:
receiving the named user code;
identifying the named user based on the named user code;
retrieving the named user audio file for the named user;
retrieving the named user information for the named user; and
outputting the named user audio file and the named user information for the named user.

17. The method of claim 15, wherein the named user registration process is performed for each of a plurality of named users including the named user before the named user playback process begins for any of the plurality of named users.

18. An automated named user audio presentation system, comprising:
a user code generation subsystem configured to generate a unique named user code for each of a plurality of named users, wherein the unique named user code is used to individually identify a named user from the plurality of named users;
a named user audio presentation subsystem having an electronic audio speaker and configured to receive the named user code or other information uniquely identifying an individual, to obtain a named user audio file based on the named user code, and to audibly output a name of each of the plurality of named users through audio playback of the named user audio file using the electronic audio speaker; and
a named user visual presentation subsystem having an electronic display and configured to receive information identifying a particular one of the plurality of named users, to obtain named user information for the particular named user, and to visually output the named user information for the particular named user using the electronic display.

19. The system of claim 18, further comprising an on-spot interface computer system comprising a named user information entry computer configured for receiving a name from a user and causing registration of the user as one of the plurality of named users.

20. The system of claim 18, wherein the named user audio presentation subsystem, the named user visual presentation subsystem, and the on-spot interface computer system are co-located at an event space for a social event in which the name of each of the plurality of named users is to be audibly presented, and wherein the user code generation subsystem is remotely-located from the event space.
